(19) United States
(12) Patent Application Publication
(10) Pub. No.: US 2008/0011770 A1
(43) Pub. Date: Jan. 17, 2008

(54) BEAD DISPENSING SYSTEM

(75) Inventor: Jacquiline Hazel Tobias, Caulfield South (AU)

Correspondence Address: KNOBBE MARTENS OLSON & BEAR LLP, 2040 MAIN STREET, FOURTEENTH FLOOR, IRVINE, CA, 92614, US

(73) Assignee: MOOSE ENTERPRISE PTY LTD, Bentleigh East (AU)

(21) Appl. No.: 11/762,544

(22) Filed: Jun. 13, 2007

(30) Foreign Application Priority Data
Mar. 23, 2007 (AU) 2007901540

(51) Int. Cl. G07F 11/46

(52) U.S. Cl. 221/189

(57) ABSTRACT

A bead dispensing system including a storage device, a bead dispensing means which includes a bead release mechanism, a conduit for guiding beads from the storage device to the bead dispensing means and a related method of creating artwork.

### FIELD OF THE INVENTION

The present invention relates to a bead dispensing system and particularly to a bead dispensing system that can be used to create an artwork using PVA beads.

### DESCRIPTION OF THE RELATED ART

Beads and other small objects, whether circular or irregular in shape, are used in arts and craft activities for both adults and children. Plastic, wooden, glass or metal beads are used in making jewelry or decorating articles including clothing and other fabrics. In a non-decorative sense beads, such as ball bearings, are used in machinery and other mechanical devices.

Polyvinyl acetate (PVA) in the form of solid round beads are also known to be used in children's artwork activities whereby beads are arranged by color on a tray (with or without a template beneath) to produce a pattern, picture or the like. Water is then sprayed onto the bead designs on the tray to meld the beads together and allow them to join into one another and create a picture.

One problem with using beads and bead like objects is that given their small size and often spherical nature they are difficult to handle and awkward to place and hold in position. One proposed solution is to provide a pen shaped bead dispenser wherein beads are stored in the body of the pen shaped dispenser. However, if the beads in the pen dispenser are used up, it can be inconvenient to dismantle the pen to refill the pen dispenser.

### SUMMARY OF THE INVENTION

In one aspect, the present invention provides a bead dispensing system including: a storage device; a bead dispensing means which includes a bead release mechanism; and a conduit for guiding beads from the storage device to the bead dispensing means.

The storage device may have more than one compartment and beads may be dispensed selectively from either compartment.

The compartments may be selected by rotating the storage device.

The bead release mechanism may be mechanically actuated.

The conduit may be tubular.

The conduit may be flexible.

A swivel may lie between the storage device and the conduit.

The storage device may be provided in an upper part of the system and the beads are dispensed under the force of gravity.

The system may further include a drying means which is operable to speed up the process of drying an artwork.

The system may further include a work area, the work area receives a tray for preparing an artwork and the tray is moveable from a working position to a drying position.

The storage device may be mounted to a housing and the housing is disposed above the work area.

The dispensing means may be hand held.

In a second aspect the present invention provides a method of creating an artwork including the steps of: releasing a sequence of beads from a storage means and into a dispensing means via a conduit; and dispensing the beads in sequence to form an arrangement of beads.

### BRIEF DESCRIPTION OF THE DRAWINGS

An embodiment of the invention will now be described by way of example only with reference to the accompanying drawings in which:

FIG. 1 is a perspective view of a bead dispensing system according to the present invention;

FIG. 2A is an exploded view of the bead dispensing system of FIG. 1;

FIG. 2B is an exploded view of the main body of the bead dispenser of FIG. 1;

FIG. 2C is an alternative exploded view of the main body of the bead dispenser of FIG. 1;

FIG. 2D is another alternative exploded view of the main body of the bead dispenser of FIG. 1;

FIG. 3A is a front view of the bead dispensing system of FIG. 1;

FIG. 3B is a side view of the bead dispensing system of FIG. 1;

FIG. 3C is a rear view of the bead dispensing system of FIG. 1;

FIG. 3D is a top view of the bead dispensing system of FIG. 1; and

FIG. 4 illustrates step by step instructions for creating an artwork using the bead dispensing system of FIG. 1.

### DETAILED DESCRIPTION OF THE PREFERRED EMBODIMENT

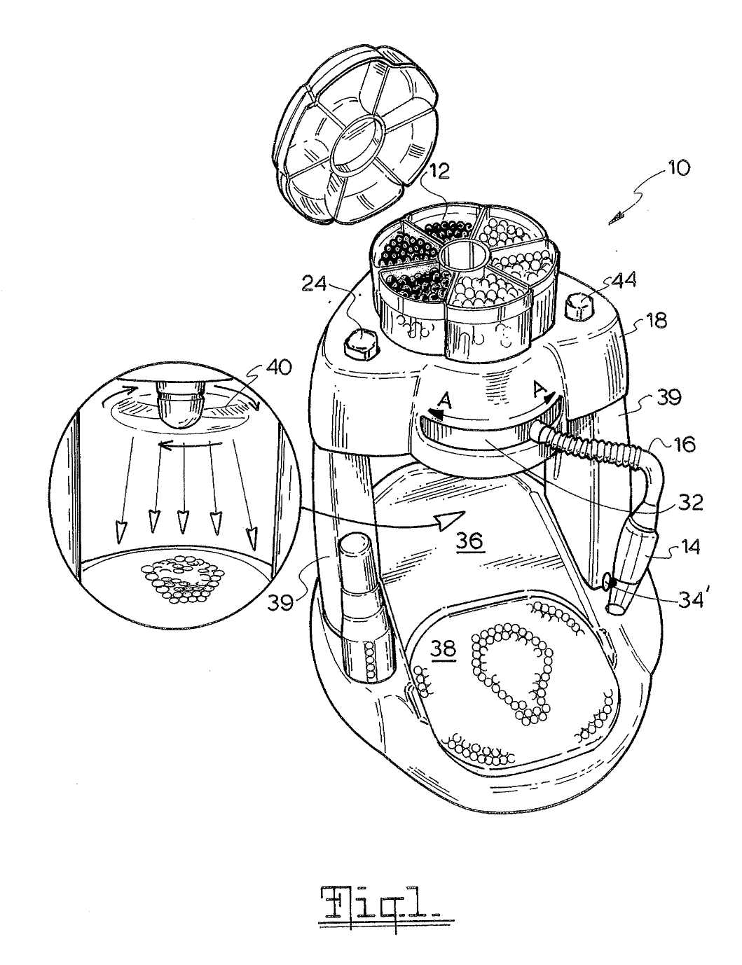

Referring to FIG. 1, a bead dispensing system 10 is shown including a storage device in the form of hopper 12, a bead dispensing means in the form of hand held dispenser 14 and a conduit in the form of flexible tube 16 which guides beads from the hopper to the dispenser 14.

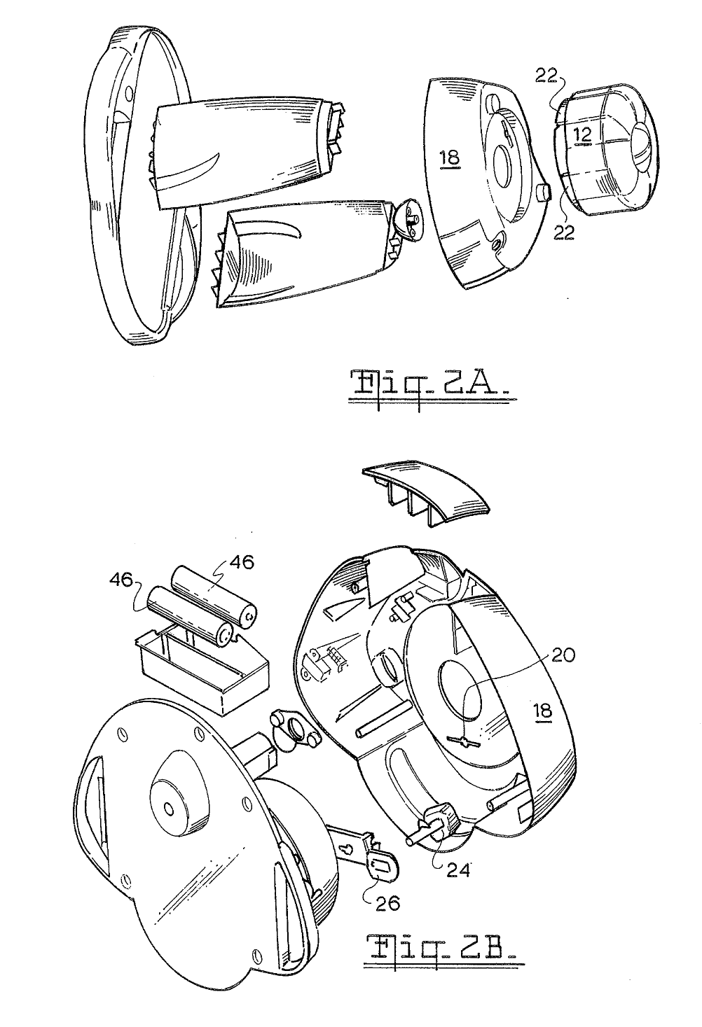

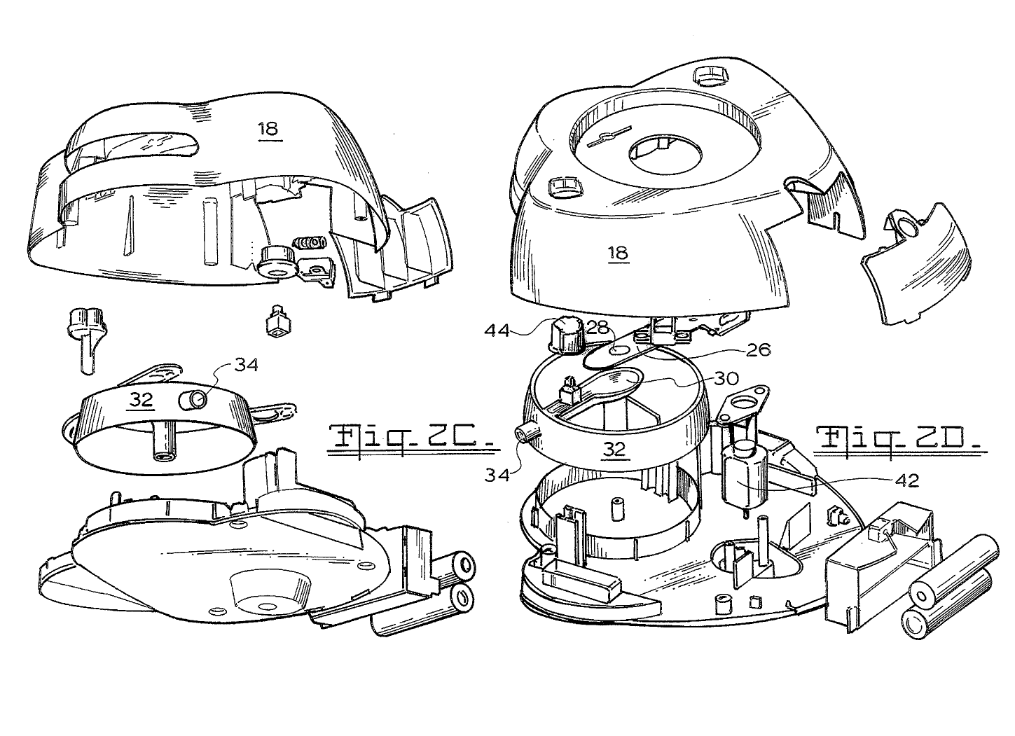

Referring to FIGS. 2A and 2B, hopper 12 is rotatably mounted to a housing in the form of main body 18 which includes an aperture 20. Hopper 12 includes six compartments, each of which is intended to hold beads of a particular color, and each of which has an aperture provided at the bottom of each compartment. By rotating hopper 12, different compartment apertures may be brought into line with aperture 20 depending upon the desired color of bead. Notches 22 align with a detent (not shown) to provide the user with an indication of the correct rotational position to align the apertures.

After the compartment containing beads of the desired color is aligned with aperture 20, beads held in the compartment may be released one at a time by pressing button 24. Pressing button 24 causes arm 26 to move to allow one bead to fall through aperture 28 and into channel 30 of swivel 32. The bead travels along channel 30 by way of gravity and out through spigot 34 to enter tube 14 (see FIG. 1). The bead then falls down tube 16 to dispenser 14. In this way, a sequence of several beads of particular colors may be released from hopper 12 and these beads may then be subsequently dispensed in sequence one at a time by pressing button 34 of dispenser 14.

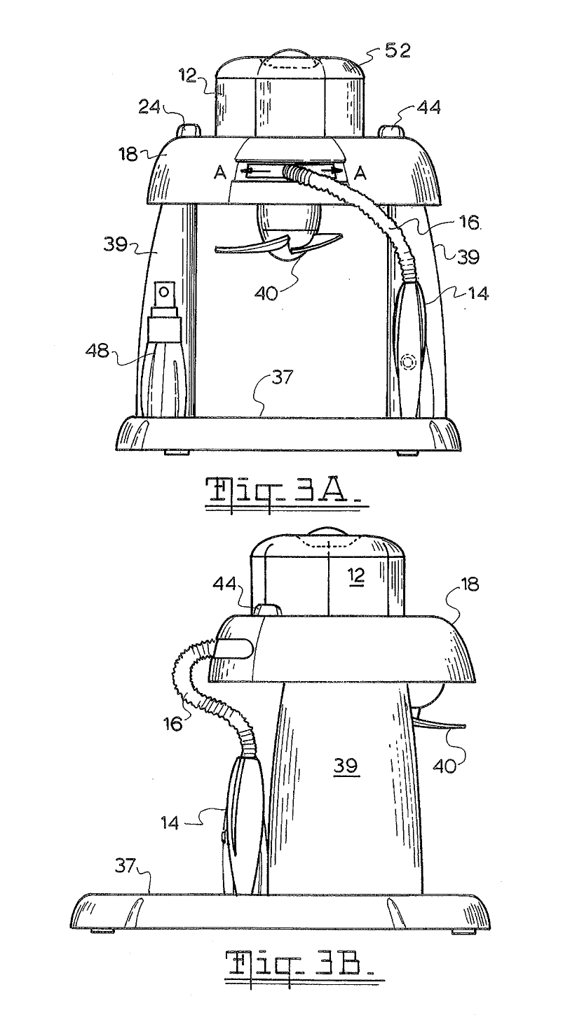

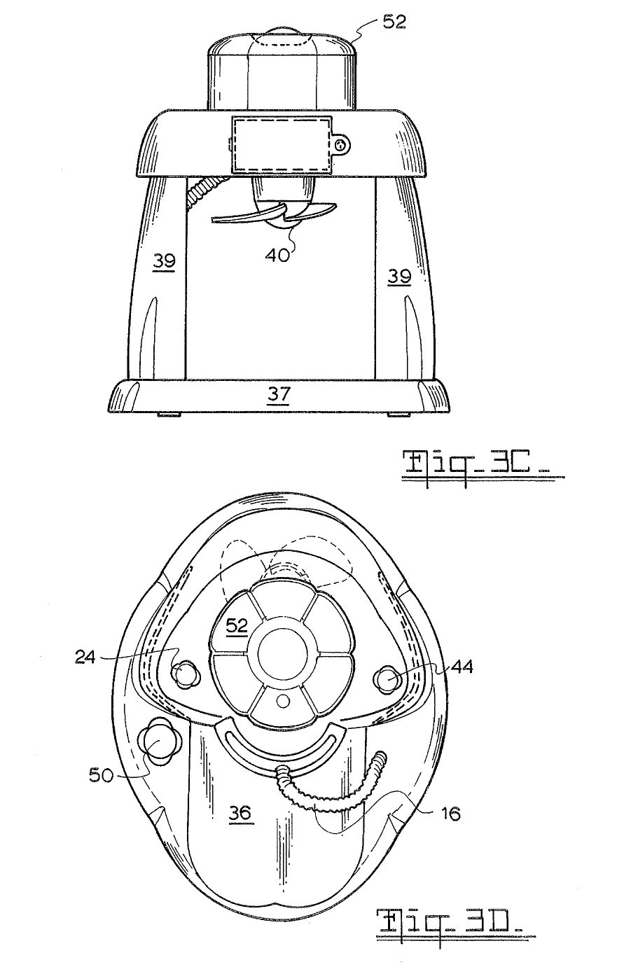

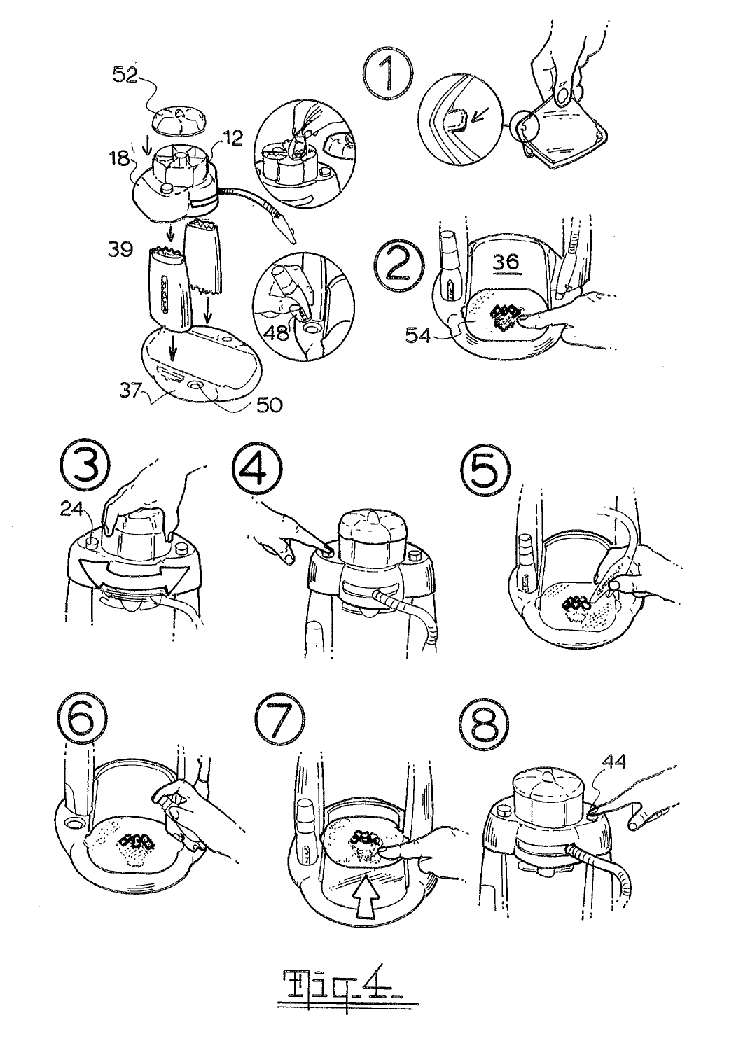

Referring to FIGS. 1 and 3A, swivel 32 may be moved from side to side in the direction of arrows A. A user may move swivel 32 to a position that is comfortable for them to use dispenser 14. In particular, right and left handed users may prefer to move the swivel to the side which corresponds to their preferred side to comfortably hold dispenser 14.

Referring again to FIG. 1, main body is disposed above a work area 36 by being mounted on legs 39. Work area 36 is shaped to receive a tray 38 which is slidable from a working position as shown in FIG. 1, to a drying position (see FIG. 3 step 7). In the drying position, tray 38 lies below a drying means in the form of foam bladed fan 40 which includes an electric motor 42 which is mounted at the underside of main body 18. Fan 40 is actuated by pressing button 44 which closes an electrical switch. Motor 42 is powered by batteries 46.

Referring to FIG. 4, the steps for creating an artwork using dispensing system 10 are illustrated. First, the system 10 is assembled by assembling main body 18, legs 39 and base 37. A small spray bottle 48 is charged with water and inserted into well 50 provided in base 37. The compartments of hopper 12 are charged with beads of differing colors and lid 52 is applied to hopper 12.

At step 1, a template 54 is selected which provides a guide for producing an artwork of a desired appearance. Template is inserted into tray 38. At step 2, the tray is placed in the working position in work area 36.

At steps 3 and 4, hopper 12 is rotated to select a desired bead color and button 24 is pressed a number of times to release a desired number of beads from the hopper 12 which fall down into dispenser 14. The hopper 12 is rotated to desired positions for each color, and button 24 pressed in each position to load dispenser 14 and tube 16 with a desired sequence of different colored beads.

At step 5, the sequence of beads is dispensed into desired positions on tray 38 by following the template 54 as a guide. If necessary, more beads can be released into tube 16 as per steps 3 and 4 above.

At step 6, the pattern of beads is complete. Spray bottle 48 is then used to spray water over the arrangement of beads.

At steps 7 and 8, tray 38 is moved to the drying position and button 44 is pressed to turn on fan 40. After a period of 5 to 10 minutes, the design dries and beads have become stuck together. The finished artwork may then be removed from tray 38 and displayed.

It will be understood to persons skilled in the art of the invention that many modifications may be made without departing from the spirit and scope of the invention.

In the above described embodiment a hopper with six compartments was used. Similarly, other embodiments may have a greater or lesser number of compartments.

What is claimed is:

1. A bead dispensing system comprising:
a storage device;
a bead dispensing means that comprises a bead release mechanism; and
a conduit for guiding beads from the storage device to the bead dispensing means.

2. A bead dispensing system according to claim 1 wherein the storage device has more than one compartment and beads may be dispensed selectively from either compartment.

3. A bead dispensing system according to claim 2 wherein the compartments are selected by rotating the storage device.

4. A bead dispenser according to claim 1 wherein the bead release mechanism is mechanically actuated.

5. A bead dispensing system according to claim 1 wherein the conduit is tubular.

6. A bead dispensing system according to claim 1 wherein the conduit is flexible.

7. A bead dispensing system according to claim 1 wherein a swivel lies between the storage device and the conduit.

8. A bead dispensing system according to claim 1 wherein the storage device is provided in an upper part of the system and the beads are dispensed under the force of gravity.

9. A bead dispensing system according to claim 1 further including a drying means which is operable to speed up the process of drying an artwork.

10. A bead dispensing system according to claim 1 further including a work area, the work area receives a tray for preparing an artwork and the tray is moveable from a working position to a drying position.

11. A bead dispensing system according to claim 10 wherein the storage device is mounted to a housing and the housing is disposed above the work area.

12. A bead dispensing system according to claim 1 wherein the dispensing means is hand held.

13. A method of creating an artwork comprising the steps of:
releasing a sequence of beads from a storage means and into a dispensing means via a conduit; and
dispensing the beads in sequence to form an arrangement of beads.
